(19) United States
(12) Patent Application Publication
(10) Pub. No.: US 2023/0121452 A1
(43) Pub. Date: Apr. 20, 2023

(54) METHOD AND APPARATUS FOR SCHEDULED LINK MUTING AT AN ACCESS POINT

(71) Applicant: Samsung Electronics Co., Ltd., Suwon-si (KR)

(72) Inventors: Vishnu Vardhan Ratnam, Plano, TX (US); Ahmed Atef Ibrahim Ibrahim, Plano, TX (US); Rubayet Shafin, Allen, TX (US); Peshal Nayak, Plano, TX (US); Boon Loong Ng, Plano, TX (US)

(21) Appl. No.: 18/052,893

(22) Filed: Nov. 4, 2022

Related U.S. Application Data
(63) Continuation of application No. 17/815,937, filed on Jul. 28, 2022.
(60) Provisional application No. 63/233,128, filed on Aug. 13, 2021.
(60) Provisional application No. 63/251,414, filed on Oct. 1, 2021.
(60) Provisional application No. 63/277,401, filed on Nov. 9, 2021.
(60) Provisional application No. 63/300,509, filed on Jan. 18, 2022.

(51) Int. Cl. H04W 76/15; H04W 28/02

(52) U.S. Cl. CPC H04W 76/15; H04W 28/0231

(57) ABSTRACT

Methods and apparatuses for scheduled link muting at an access point. An access point (AP) multi-link device (MLD) comprises a transceiver and a processor operably coupled to the transceiver. The processor is configured to generate an information element (IE) configured to indicate unavailability of a link, the information element comprising an indication of a duration of link disablement; and when a value of the indicated duration of the link disablement has elapsed, enable the link, wherein the IE is included in a broadcast frame, and the transceiver is configured to transmit the broadcast frame.

### CROSS-REFERENCE TO RELATED APPLICATION(S) AND CLAIM OF PRIORITY

This application is a continuation of pending U.S. application Ser. No. 17/815,937 filed on Jul. 28, 2022, which claims priority under 35 U.S.C. § 119(e) to U.S. Provisional Patent Application No. 63/233,128 filed on Aug. 13, 2021, U.S. Provisional Patent Application No. 63/251,414 filed on Oct. 1, 2021, U.S. Provisional Patent Application No. 63/277,401 filed on Nov. 9, 2021, and U.S. Provisional Patent Application No. 63/300,509 filed on Jan. 18, 2022, which are hereby incorporated by reference in their entirety.

### TECHNICAL FIELD

This disclosure relates generally to scheduling link muting at an access point. Embodiments of this disclosure relate to methods and apparatuses for enabling notification-based temporary termination of service from an AP on a link to one or more non-AP MLDs or STAs, while also providing sufficient information and features for STAs to minimize their degradation of service.

### BACKGROUND

Wireless local area network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

IEEE 802.11be supports multiple bands of operation, where an access point (AP) and a station (STA) can communicate with each other, called links. However, on any band/link, an AP may be subject to transmit power regulations and furthermore may need to suspend operation temporarily if it detects an incumbent technology that is operating on the channel with priority access, e.g., RADAR. In addition, for the purpose of fairness of access, the AP may also desire to identify and cease service to STAs whose traffic patterns violate certain a priori agreements such as, for example, a low latency traffic flow generating data-traffic above a certain threshold. Finally, in a multi-AP scenario, where multiple APs may co-exist and operate on the same bands with some form of coordination, an AP may desire to temporarily cease service on one link to reduce interference for a coordinated AP operating on same link. Thus, as summarized above, due to transmit power regulations, battery concerns, accommodating incumbent spectrum users, perform traffic policing or reduce interference, an AP may have to make an unscheduled, fast and temporary suspension of service to one or more STAs on a link.

However, IEEE 802.11be also aims to provide certain protection and service guarantees to different traffic categories/use-cases. Thus, mechanisms are also needed to enable the AP to minimize performance degradation of some STAs or traffic categories upon such a temporary suspension of service.

### SUMMARY

Embodiments of the present disclosure provide methods and apparatuses for enabling notification-based temporary termination of service from an AP on a link to one or more non-AP MLDs or STAs, while also providing sufficient information and features for STAs to minimize their degradation of service.

In one embodiment, an access point (AP) multi-link device (MLD) comprises a transceiver and a processor operably coupled to the transceiver. The processor is configured to generate an information element (IE) configured to indicate unavailability of a link, the information element comprising an indication of a duration of link disablement; and when a value of the indicated duration of the link disablement has elapsed, enable the link, wherein the IE is included in a broadcast frame, and the transceiver is configured to transmit the broadcast frame.

In another embodiment, a non-AP MLD comprises a transceiver configured to receive an information element (IE) configured to indicate unavailability of a link, the IE included in a broadcast frame, the IE comprising an indication of a duration of the link disablement. A processor is operably coupled to the transceiver, the processor configured to determine that disablement of the link will occur, wherein when a value of the indicated duration of the link disablement has elapsed, the transceiver is configured to receive an indication that the link has been enabled.

In another embodiment, a method performed by an AP MLD comprises generating an information element (IE) configured to indicate unavailability of a link, the IE included in a broadcast frame, the IE comprising an indication of a duration of link disablement; when a value of the indicated duration of the link disablement has elapsed, enabling the link; and transmitting the broadcast frame.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example of an individually addressed SMNF according to embodiments of the present disclosure;

FIG. 4 illustrates an example of SMNF format as subfields of the Common info field of the Multi-link element according to embodiments of the present disclosure;

FIG. 5 illustrates an example of SMNF format as subfields of the Link info field of the Multi-link element according to embodiments of the present disclosure;

FIG. 6 illustrates an example of a flow diagram depicting the SMNF transmission and operation for an AP-MLD according to embodiments of the present disclosure;

FIG. 7 illustrates an example of a flow diagram depicting the SMNF transmission and operation for a non-AP-MLD according to embodiments of the present disclosure;

FIG. 8 illustrates a method of wireless communication performed by an AP according to embodiments of the present disclosure; and

FIG. 9 illustrates a method of wireless communication performed by a non-AP according to embodiments of the present disclosure.

### DETAILED DESCRIPTION

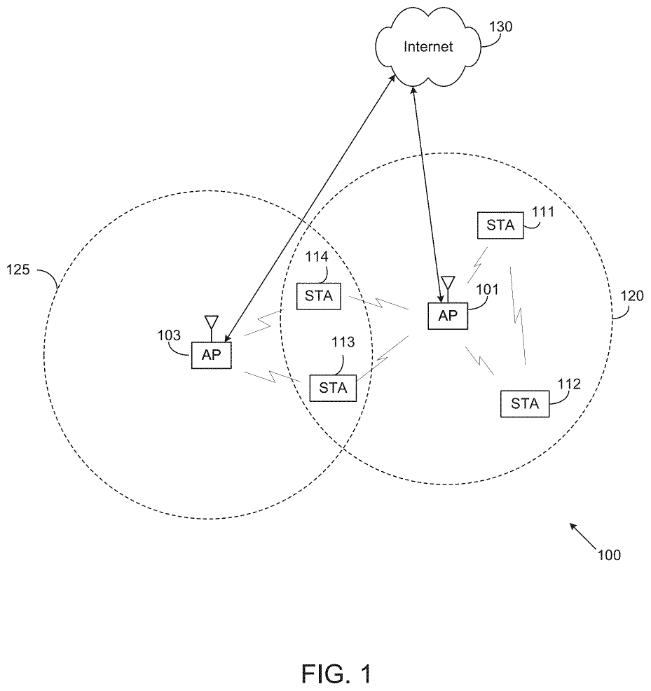

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated into the present disclosure as if fully set forth herein:

[1] IEEE P802.11be/D1.0—Draft Standard for Information technology—Telecommunications and information exchange between systems Local and metropolitan area networks—Specific requirements—Part 11: Wireless LAN Medium Access Control (MAC) and Physical Layer (PHY) Specifications—Amendment 8: Enhancements for extremely high throughput (EHT).

[2] IEEE 802.11-2020—IEEE Standard for Information Technology—Telecommunications and Information Exchange between Systems—Local and Metropolitan Area Networks—Specific Requirements—Part 11: Wireless LAN Medium Access Control (MAC) and Physical Layer (PHY) Specifications.

[3] IEEE 802.11-21/0792r3, “PDT for CC34 Resolution for CID 3222”.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as an STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating notification-based temporary termination of service from an AP on a link to one or more non-AP MLDs or STAs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

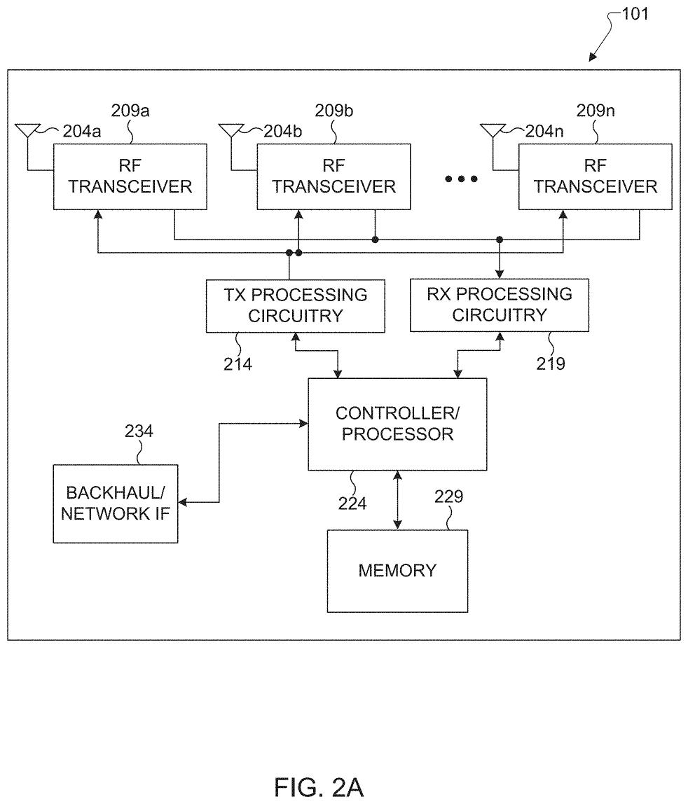

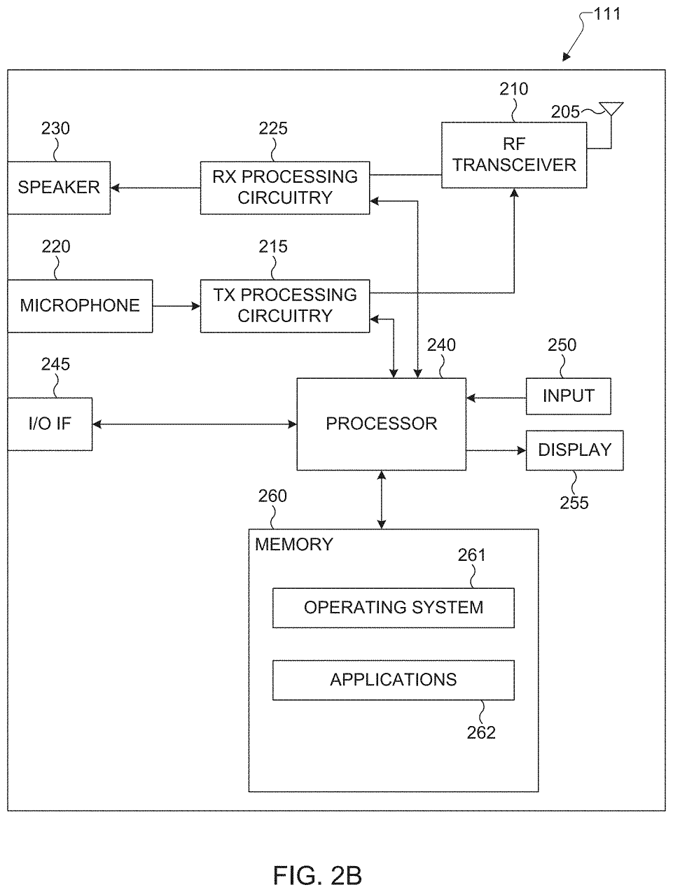

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n, multiple RF transceivers 209a-209n, transmit (TX) processing circuitry 214, and receive (RX) processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including facilitating notification-based temporary termination of service on a link. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

The STA 111 includes antenna(s) 205, a radio frequency (RF) transceiver 210, TX processing circuitry 215, a microphone 220, and receive (RX) processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate notification-based temporary termination of service on a link. In some embodiments, the controller/processor 240 includes at least one microprocessor or microcontroller.

The controller/processor 240 is also capable of executing other processes and programs resident in the memory 260, such as operations for facilitating notification-based temporary termination of service on a link. The controller/processor 240 can move data into or out of the memory 260 as required by an executing process. In some embodiments, the controller/processor 240 is configured to execute a plurality of applications 262, such as applications for detect interference from a neighboring BSS and inform the associated AP of the interference. The controller/processor 240 can operate the plurality of applications 262 based on the OS program 261 or in response to a signal received from an AP. The main controller/processor 240 is also coupled to the I/O interface 245, which provides STA 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

Current mechanisms for performing a suspension of service on a link include three methods. These methods and their drawbacks are enumerated below:

Permanent tear down of a link between an AP and STA: The tear-down is unnecessary in scenarios where suspension of service on a link may be temporary and it may lead to an unnecessarily large overhead and poor service quality for the corresponding non-AP MLDs or STAs. Furthermore, such a tear-down process does not address the applications involving service suspension for specific STAs or traffic identifiers (TIDs).

Changing the traffic identifier (TID)-to-link mapping: The TID-to-link mapping is a method that is specific to multi-link devices, which can be used to re-route specific TIDs of an STA away from a particular wireless link. While this can be used for suspension of service on a link, the current TID-to-link mapping procedure involves a two-way negotiation process between an AP MLD and a non-AP MLD. The AP MLD may not always have the available time to negotiate such a temporary termination of service. Furthermore, the TID-to-link mapping involves a permanent change to the mapping and it is not schedule-based, so a start and end time for the temporary mapping can't be provided. Finally, this method is not applicable to STAs that are not MLDs or with MLDs with TID-to-link mapping disabled.

Transmission of a quiet element or quiet channel element: This method can indeed be used for temporary suspension of transmissions on a link but it can only be broadcast. Thus it is not applicable to scenarios where only a single STA or a single TID has to be muted. Similarly, in the broadcast context it can't be used to only mute uplink transmissions to or only mute downlink transmissions from an AP.

Correspondingly, there is a need for methods to enable notification-based temporary termination of service from an AP on a link to one or more non-AP MLDs or STAs, while also providing sufficient information and features for STAs to minimize their degradation of service.

As described above, to serve various applications there is a need for a notification based mechanism for an AP to temporarily pause service on a link for one or more STAs or TIDs. This disclosure refers to this operation as service muting. To enable the above, this disclosure proposes either a new collection of information elements or a new frame, called the Service Muting Notification Frame (SMNF), that can be transmitted by the AP MLD prior to muting. Although we refer to it as a ‘frame’ for convenience, the SMNF can either be transmitted as a new management frame or action frame, or it can be a collection of new information elements that are included in an existing frame such as the beacon frame or the probe response frame.

The SMNF may include one or more of the following information elements/sub-elements/fields:
1. A destination address (DA) identifying the recipient of the frame.
2. An indication of whether the frame is for muting or unmuting.
3. An indication of the one or more link identifiers (IDs) that will be muted/unmuted.
4. An indication of the start time of the service muting/unmuting (measured in either target beacon transmit times (TBTTs) or time units (TUs).
5. An indication of the duration of service muting if applicable (measured in TBTTs or TUs).
6. An indication of the minimum duration of service muting if applicable (measured in TBTTs or TUs).
7. An indication of the maximum duration of service muting if applicable (measured in TBTTs or TUs).
8. An indication of the interval to the next following occurrence of service muting if periodic and applicable (measured in TBTTs or TUs).
9. An indication of the TIDs associated with the DA that shall be muted/unmuted.
10. An indication of the priority of the muting which can help determine which STAs shall comply with it.
11. An indication of the links to which all or a subset of the affected TIDs may be re-mapped.
12. An indication of whether the muting/unmuting is only for uplink direction (non-AP to AP MLD), downlink direction (AP to non-AP MLD) or both directions.

Some of the details and operating functions of these fields are described below:
1. Destination Address field: The SMNF can either be unicast separately to each non-AP device by using the corresponding MAC address in the DA, can be multi-cast to a group of STAs via a group MAC address, or can be broadcast to all the associated STAs operating on that link and associated with the AP by using the broadcast address in the DA.
2. Link Status field: In one embodiment, the duration of the muting performed by the AP may be non-deterministic. In this case, a separate indication may be required to identify if the SMNF is for muting or for unmuting, which is conveyed by the Link Status field. This field may have a single bit indicating whether the frame is for muting or unmuting. In another embodiment, an SMNF may include the status of all links of an AP MLD, in which case this field may be a bit map, indicating the new status of each link after the start time field duration.
3. Link ID field: In some embodiments, the SMNF can be transmitted by an AP MLD not only on the one or more links to be muted but may also be transmitted on other links to enable other MLD non-APs to know of the upcoming muting more quickly. In such a scenario, a Link ID may be included to identify which is the link that will be muted. In one embodiment, an SMNF from an AP MLD may indicate status of all associated links and may thus contain separate fields for each link, in which case such a link ID indication may not be required.
4. Start time field: This field may indicate the time duration or the TBTT count to the start of the muting/unmuting operation. In one embodiment, the SMNF may need to be transmitted by the AP at least a threshold number of TBTTs (called MinTbttToStartMute here) ahead of the start of the service muting or unmuting.
5. Duration field: This field is an indication of the duration of the service muting. In one embodiment, the muting duration can be a default predetermined value of TbttMuteDuration.
6. Minimum duration field: In one embodiment where the duration of muting is not deterministic or known apriori, this identifies the minimum duration of time for which the muting will be performed. The STA can assume that no communication with the AP will be feasible for this duration. Correspondingly it can either enter a doze state and save power, or can determine if it needs to send a TID-to-link mapping request to the AP MLD to re-map latency sensitive traffic to another link etc. In one embodiment, this field may not be applicable to the case of unmuting.
7. Maximum duration field: In one embodiment where the duration of muting is not deterministic or known apriori, this field is an indication of the maximum or worst case duration of the muting. The non AP STA can use this information to decide, for example, the worst case service quality and latency and therefore take necessary actions. In one embodiment this maximum duration can be a pre-determined constant in the standard, for example the BSSMaxIdlePeriod, in which case a sub-field may not be required. In one embodiment, this field may not be applicable to the case of unmuting.
8. Periodicity of muting field: This is an indication of the time duration to the next expected muting operation to be performed by the AP for the same DA. This information can be used, for example, by the STA to determine if transmission of this link to the AP is viable for all of its traffic identifiers (TIDs) or not. In one embodiment, this field may not be applicable to the case of unmuting.
9. TID field: In some embodiments, the AP may desire to mute only traffic from certain traffic identifiers associated with the STA corresponding to the DA. For such embodiments, this field may indicate the TID list for which the muting/un-muting is applicable. An example can be the use of the SMNF to perform traffic policing and/or admission control on a certain TID that does not comply with some regulatory constraints.
10. Muting Priority field: In some embodiments, a field may indicate the priority of the muting decision. Correspondingly, the STA corresponding to the DA shall determine which TIDs shall comply with the muting request. For example, a TID mapped to a restricted target wake time interval (rTWT), might not be muted by a low priority SMNF.
11. Backup Link field: In the case of MLDS, this field may indicate the new links to which traffic corresponding to the muted links may be remapped temporarily till the old link is unmuted. This can be applicable, for example, in scenarios where some TIDs are only mapped to the muted links. In an example scenario, this field may be absent and by default all the traffic corresponding to muted links may be mapped to all the active links.
12. Direction of muting field: In case of only downlink muting, the AP may not contend for a transmit opportunity (TXOP) on the corresponding link to transmit data to the non-AP STAs. However, the STAs can still contend for a TXOP and transmit packets to the AP. The AP may still be allowed to send an ACK frame for the uplink packets it receives. Such a unidirectional muting can be beneficial, for example, to meet transmit power regulations or reduce interference generated by the AP. Similarly, in case of uplink muting, only the AP is allowed to contend for the TXOP to transmit packets to the non-AP STAs. The non-AP STAs are however allowed to send an ACK frame in response to a received downlink packet. In case of bi-directional muting, neither the AP MLD nor the associated non-AP STAs are allowed to access the channel to communicate with the other. However, the non-AP STAs may still be allowed to contend for the link to send packets to other receivers, such as in soft-AP, tunnel-link-direct-setup (TDLS) operations etc. For transmit power regulation or to reduce interference, muting on only downlink may be sufficient. For reducing power consumption, muting on both uplink and downlink may be beneficial. Including the TIDs in element allows muting certain traffic IDs for traffic policing or admission control.

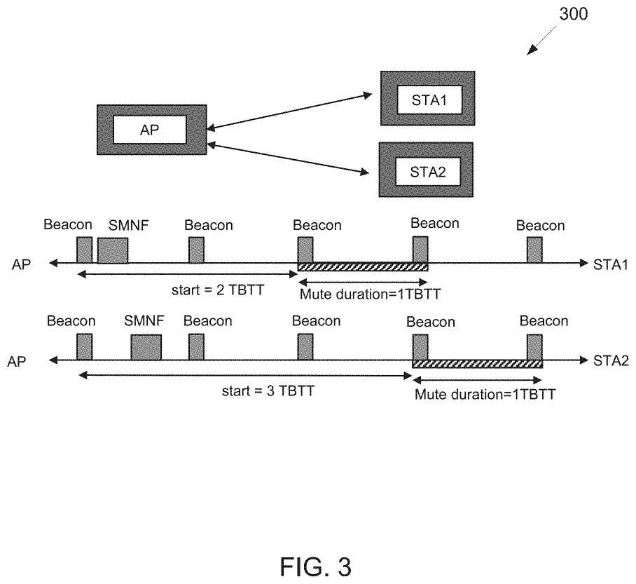

FIG. 3 illustrates an example of an individually addressed SMNF 300 according to embodiments of the present disclosure. The embodiment of the individually addressed SMNF 300 illustrated in FIG. 3 is for illustration only. FIG. 3 does not limit the scope of this disclosure to any particular implementation of the example of an individually addressed SMNF 300.

In the example illustrated in FIG. 3, such an SMNF is being transmitted by an AP to two different STAs. In this illustration, both the mute start time field and the mute duration values are measured in TBTT and the corresponding values are as depicted in FIG. 3. Using the sub-fields of a received SMNF, an STA may take a corresponding action. For example, using the minimum duration of muting and interval to a next occurrence of muting, an STA can decide to either enter a doze state and save power, or to determine if it needs to disassociate and connect with a new AP to ensure its quality of service. Similarly, a non-AP MLD may decide to send a TID-to-link mapping request to the AP MLD to re-map latency sensitive traffic to another link. If the non-AP MLD is unhappy with the TID remapping to a backup link, it may initiate a re-association request frame with a new suggested TID-to-link mapping request element or may initiate a tear-down procedure.

Several concrete example embodiments for the implementation of the aforementioned SMNF in compliance with the WiFi 802.11be D1.01 draft [2] are described below. In one embodiment, the SMNF can be of the EHT protected action frame category with action field value of 6 as indicated in table 1.

TABLE 1
Proposed protected EHT Action field values

| Value | Meaning | Time priority |
|---|---|---|
| 0 | TID-To-Link Mapping Request | No |
| 1 | TID-To-Link Mapping Response | No |
| 2 | TID-To-Link Mapping Teardown | No |
| 3 | NSEP Priority Access Enable Request | No |
| 4 | NSEP Priority Access Enable Response | No |
| 5 | NSEP Priority Access Teardown | No |
| 6 | Service Muting Notification Frame | No |
| 7-255 | Reserved | |

In one embodiment of the Service Muting Notification Frame, the link muting duration is known deterministically and is only transmitted on a link on which the muting is scheduled. Such a frame format is illustrated in Table 2 below. Note that the DA is not included in the format in Table 2 since it will be included in the MAC header which is not shown in the frame format. In this example, the muting may always be applicable to both uplink and downlink directions and also applicable to all TIDs of the DA. Thus this example embodiment can be interpreted as an individually addressed quiet element.

TABLE 2
Embodiment of Service Muting Notification Frame format

| Order | Information | Size |
|---|---|---|
| 1 | Category | 1 octet |
| 2 | Protected EHT Action | 1 octet |
| 3 | Start time subfield | 1 or 2 octets |
| 4 | Duration subfield | 1 or 2 octets |
| 5 | Link Muting Periodicity subfield | 1 or 2 octets |

In one embodiment of the Service Muting Notification Frame, the link muting duration is known deterministically and is only transmitted on a link on which the muting is scheduled. Such a frame format is illustrated in Table 3 below. In this example, the direction of muting field may have two bits. A value of 00 may indicate bi-directionally active, 01 may indicate downlink only muting, 10 may indicate uplink only muting and 11 may indicate both uplink and downlink muting. Here the backup link ID may be an optional field which is transmitted to convey to the DA the alternative link onto which the TIDs of the muted link can be re-mapped temporarily. In one embodiment, in an individually addressed Service Muting Notification Frame, an AP MLD STA may not transmit the back-up link field to a non MLD AP. In another embodiment, a non MLD STA can ignore the back-up link field if present in the Service Muting Notification Frame. In one embodiment where the destination MAC address is the broadcast address, the TID list may be applicable to all the associated STAs that can decode the Service Muting Notification Frame.

TABLE 3
Embodiment of Service Muting Notification Frame format

| Order | Information | Size |
|---|---|---|
| 1 | Category | 1 octet |
| 2 | Protected EHT Action | 1 octet |
| 3 | Start time subfield | 1 or 2 octets |
| 4 | Duration subfield | 1 or 2 octets |
| 5 | Link Muting Periodicity subfield | 1 or 2 octets |
| 6 | Applicable TID list | variable |
| 7 | Back up Link ID | 1 octet |
| 8 | Direction of muting | 2 bits |

In one embodiment, instead of an applicable TID list, a priority field may be included to help determine which STAs or which TIDs of an STA should comply with the service muting notification frame. This embodiment is depicted in Table 4. An example of some of the priority levels are shown in Table 5. When the destination MAC address is the broadcast address, each associated STA that decodes the Service Muting Notification Frame will independently determine whether one or more of its TIDs needs to comply with the service muting notification.

TABLE 4
Embodiment of Service Muting Notification Frame format

| Order | Information | Size |
|---|---|---|
| 1 | Category | 1 octet |
| 2 | Protected EHT Action | 1 octet |
| 3 | Start time subfield | 1 or 2 octets |
| 4 | Duration subfield | 1 or 2 octets |
| 5 | Link Muting Periodicity subfield | 1 or 2 octets |
| 6 | Priority level | 1 octet or less |
| 7 | Back up Link ID | 1 octet |
| 8 | Direction of muting | 2 bits |

TABLE 5
Example of priority values

| Value | Meaning |
|---|---|
| 0 | All TIDs > 0 are supposed to comply and rTWT also have to |
| | comply |
| 1 | All TIDs > 0 are supposed to comply and rTWT is exempt |
| 2 | All TIDs > 1 are supposed to comply and rTWT is exempt |
| 3 | All TIDs > 2 are supposed to comply and rTWT is exempt |
| 4 | All TIDs > 3 are supposed to comply and rTWT is exempt |
| 5 | All TIDs > 4 are supposed to comply and rTWT is exempt |
| 6 | All TIDs > 5 are supposed to comply and rTWT is exempt |
| 7-255 | unassigned |

In one embodiment, involving an MLD AP and an MLD STA, the Service Muting Notification Frame can contain the muting status for all the links associated with the AP MLD. In addition, instead of having a back-up link field, an explicit TID-to-link mapping element (as defined in Section 9.4.2.259d of [2]) can be transmitted as part of the Service Muting Notification Frame. This example embodiment is depicted in Table 6 below. In this scenario, the TID-to-link mapping can be a notification based mapping transmitted by an AP MLD, that the non-AP MLD has to use for the duration of the muting. If the non-AP MLD is unhappy with the new TID-to-link mapping, it may initiate a re-association request frame with a new suggested TID-to-link mapping request element or may initiate a tear-down procedure. The AP MLD may include the TID-to-link mapping only in individually addressed Service Muting Notification Frames if the DA corresponds to a non-AP MLD. Additional rules may also be applied such as: “the new TID-to-link mapping shall not reduce the number of mapped links to each TID, when compared to previously negotiated TID-to-link mapping”, “the new TID-to-link mapping shall not update the link mapping for TIDs that are unaffected by the link muting” etc. The direction of muting field may now be bitmap (2 bits per affiliated link) which identifies which of the links are muted and in uplink or in downlink. For any link, a value of 00 may indicate bi-directionally active, 01 may indicate downlink only muting, 10 may indicate uplink only muting and 11 may indicate both uplink and downlink muting. In one embodiment, if a non-AP MLD receives a Service Muting Notification Frame on link1, with the Link ID bitmap values for another link2 set to 11, then the non-AP MLD shall apply the muting instruction to an STA2 operating on link2.

TABLE 6
Embodiment of Service Muting Notification Frame format

| Order | Information | Size |
|---|---|---|
| 1 | Category | 1 octet |
| 2 | Protected EHT Action | 1 octet |
| 3 | Start time subfield | 1 or 2 octets |
| 4 | Duration subfield | 1 or 2 octets |
| 5 | Link Muting Periodicity subfield | 1 or 2 octets |
| 6 | TID-to-Link Mapping element | variable |
| 7 | Direction of muting bitmap | 2 bits per link |

In yet another example embodiment, the duration of the muting may be unknown apriori. In this scenario the same Service Muting Notification Frame can be used to both mute and unmute a link. To convey this information, the frame may have a direction of muting subfield, that indicates if the frame is being used to mute or unmute and in uplink/downlink or both. For example, if a link is currently muted for a DA, and the DA receives a link muting notification frame with a direction of muting field=00, it can be interpreted as an unmuting operation. Furthermore, details about the minimum and maximum duration of mute may be provided to enable the STAs to take action to ensure their quality of service. The frame structure of this example embodiment is illustrated in Table 7.

TABLE 7
Embodiment of Service Muting Notification Frame format

| Order | Information | Size |
|---|---|---|
| 1 | Category | 1 octet |
| 2 | Protected EHT Action | 1 octet |
| 3 | Start time subfield | 1 or 2 octets |
| 4 | Minimum Duration subfield | 1 or 2 octets |
| 5 | Maximum Duration subfield | 1 or 2 octets |
| 6 | Link Muting Periodicity subfield | 1 or 2 octets |
| 7 | Applicable TID list | variable |
| 8 | Back up Link ID list | 1 octet |
| 9 | Direction of muting | 2 bits |

In another embodiment, the SMNF can be conveyed using new information fields in an existing management frame such as the probe response frame or the beacon frame. In this embodiment, the muting can be notified by including an EHT Operation element in the existing management frame, with the SMNF being included as one or more sub-fields of the EHT Operation Information field of the EHT Operation element. One example illustration of the EHT operation element in this embodiment is depicted in Table 8, where we include the start time, duration, and direction of muting/unmuting as subfields of the EHT Operation element. Note however that the depicted set of sub-fields is only exemplary other combinations of sub-fields of the SMNF can also be included as considered in the previous embodiments above.

In yet another embodiment the SMNF can be included as one or more sub-fields of the Multi-link element transmitted by the existing management frame.

TABLE 8
Embodiment of Service Muting Notification Frame
format as subfields of the EHT Operation element

| Subfield | Definition | Size |
|---|---|---|
| Channel Width | This field defines the EHT | |
| | BSS bandwidth. | |
| CCFS | This field provides the | |
| | channel center frequency | |
| | segment information for a | |
| | 20, 40, 80, 160, or 320 | |
| | MHz EHT BBS. | |
| Disabled sub- | This subfield indicates | |
| channel bitmap | whether the disabled subchannel | |
| present | bitmap field is present or not. | |
| Start time subfield | Indicates start time of muting | 1 or 2 |
| | in TBTT | octets |
| Duration subfield | Indicates duration of the muting | 1 or 2 |
| | in TBTT | octets |
| Direction of muting | Indicates direction of muting of link | 2 bits |

In another realization of one or more embodiments described above, the link muting may be referred to as link disablement. In this realization, the indicated details of the link disablement can be added as new fields of the EHT element instead of being included in the EHT operation information. The format of the EHT Operation element can be as shown below:

Format of EHT operating element

| | | | | Disabled | |
|---|---|---|---|---|---|
| | | Element | EHT | Sub- | Link Dis- |
| Element | | ID | Operation | channel | ablement |
| ID | Length | Extension | Information | Bitmap | Parameters |
| 1 octet | 1 octet | 1 octet | | 0 or 2 | 0 or 4 |
| | | | | octets | octets |

Furthermore, the format of the link disablement parameters field can be as shown below:

Format of Link Disablement Parameters

| Link disablement | Link disablement | Link disablement |
|---|---|---|
| count | period | duration |
| 1 octet | 1 octet | 2 octets |

Here the ‘Link Disablement Count’ subfield may indicate the number of TBTTs until the indicated link is disabled. A value of 0 may indicate the indicated link is already disabled. The ‘Link Disablement Periodicity’ subfield indicates the interval between periodic repetitions of the link disablement in TBTTs, in case of periodically scheduled disablement. A value of 0 indicates that the disablement is not periodic. The ‘Link Disablement Duration’ subfield indicates the number of time units (TUs) the indicated link disablement will apply for. If the duration is unknown, the value may be set to 65535. In addition, the indication of whether a link disablement is scheduled and the corresponding ‘Link Disablement Parameters’ field is present in the EHT operation element can be indicated in a new subfield of the ‘EHT operation information’ field called ‘Link Disablement indication’ bit as shown below.

Subfields of EHT operation information field

| Subfield | Definition | Size |
|---|---|---|
| Channel Width | This field defines the EHT BSS bandwidth. | |
| CCFS | This field provides the channel center | |
| | frequency segment information for a 20, 40, | |
| | 80, 160, or 320 MHz EHT BBS. | |
| Disabled sub- | This subfield indicates whether the disabled | |
| channel bitmap | subchannel bitmap field is present or not. | |
| present | | |
| Link | This bit indicates whether the current link is | 1 bit |
| Disablement | scheduled to be (or is already) disabled, and if | |
| indication | the link disablement parameters are present | |

The AP MLD may announce a link disablement by setting the ‘Link Disablement Indication’ bit of the ‘EHT Operating Information’ field of the EHT operating element to 1, and by setting the ‘Link Disablement Count’ subfield of the ‘Link Disablement Parameters’ field of the EHT operating element to a non-zero value. The AP MLD may announce a periodic link disablement by additionally setting the ‘Link Disablement Period’ subfield of the ‘Link Disablement Parameters’ field in the EHT Operation element to a non-zero value. A disabled link which is announced with the ‘Link Disablement Duration’ subfield of the ‘Link Disablement Parameters’ field of the EHT operating element not set to 65535, will be enabled by the AP MLD before the expiry of the time indicated in the Link Disablement Duration field.

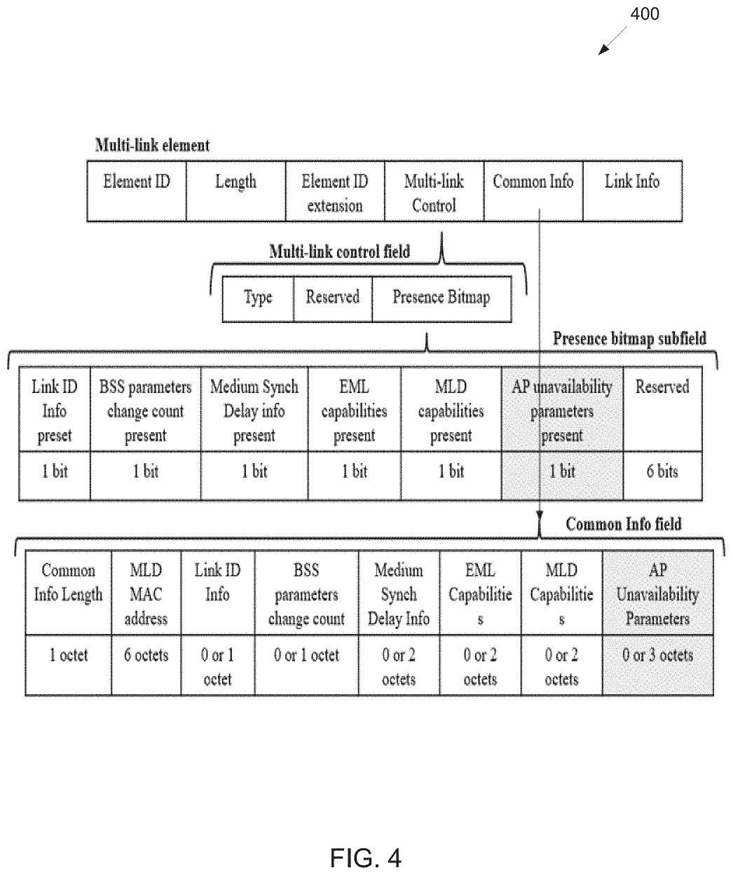

FIG. 4 illustrates an example of SMNF format 400 as subfields of the Common info field of the Multi-link element according to embodiments of the present disclosure. The embodiment of the SMNF format 400 illustrated in FIG. 4 is for illustration only. FIG. 4 does not limit the scope of this disclosure to any particular implementation of the example of SMNF format 400.

In another variant of one or more of the embodiments described above, the SMNF can be conveyed using new information fields in the multi-link element that is transmitted in existing management frames such as the probe response frame, beacon frame etc. In this embodiment, the muting can be referred to as AP unavailability, and can be notified by including new optional subfields in the Common Info field and/or the Link Info field of the multi-link element. For example, the indication of AP unavailability of a first AP of an AP MLD can be carried in the ‘AP Unavailability parameters’ of the Common Info field of the Multi-link element transmitted by a first AP as shown in FIG. 4. An indication of the presence of this optional AP Unavailability parameters field in the Common Info field can be conveyed using the “AP Unavailability Parameters Present” bit in the presence bitmap subfield of the multi-link control field of the basic multi-link element transmitted by the first AP.

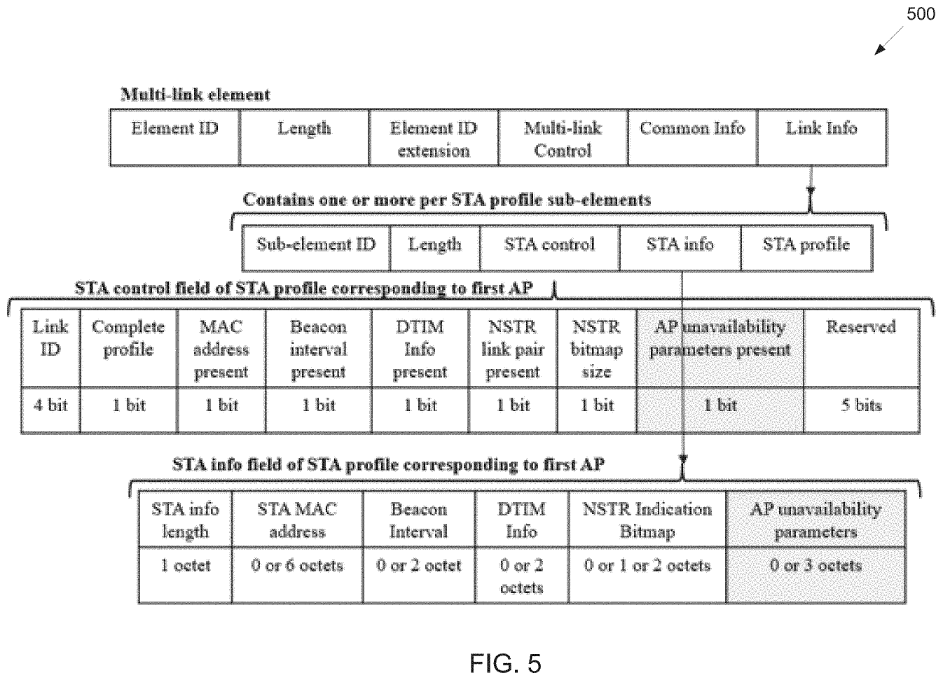

FIG. 5 illustrates an example of SMNF format as subfields of the Link info field of the Multi-link element according to embodiments of the present disclosure. The embodiment of the SMNF format 500 illustrated in FIG. 5 is for illustration only. FIG. 5 does not limit the scope of this disclosure to any particular implementation of the example of SMNF format 500.

In addition, an indication of the AP unavailability for the first AP of the AP MLD may also be carried in the ‘AP Unavailability parameters’ of the ‘STA info subfield’ of the ‘Link Info field’ of the ‘per STA profile sub-element’ corresponding to the first AP, that is included in the Link Info field of the Multi-link element transmitted by a second AP of the same AP MLD as shown in FIG. 5. An indication of the presence of this optional AP Unavailability parameters field in the ‘STA Info field’ of a ‘per STA profile sub-element’ can be conveyed using the “AP Unavailability Parameters Present” bit in the ‘STA control subfield’ of the same ‘per STA profile sub-element’.

In one example, the information in the ‘AP Unavailability parameters’ in Tables 9 and 10 can be an ‘AP unavailability count’ and an ‘AP Unavailability duration’ as shown below. The ‘AP unavailability count’ can be of length 1 octet and be measured in TBTTs and can indicate the time till the start of the upcoming AP unavailability. The value can be set to 0 when the AP is already unavailable. The ‘AP Unavailability duration’ can either be of length 2 octets, can be measured in TUs or TBTTs and can indicate the remaining duration of the AP unavailability. If the duration is unknown, the value may be set to 65535. When the ‘AP unavailability count’ is >0, then the ‘AP unavailability duration’ indicates the duration of the upcoming AP unavailability. When the ‘AP unavailability count’=0, then the ‘AP unavailability duration’ may indicate the remaining duration of the AP unavailability.

Format of AP unavailability Parameters

| AP unavailability count | AP unavailability duration |
|---|---|
| 1 octet | 2 octets |

In one embodiment, the start of the unavailability or the end of unavailability of an AP of an AP MLD shall be considered as a critical update thus causing an increase in the Check beacon field that is transmitted in the next beacon frames and TIM frames by any AP of the same AP MLD. When an AP of an AP MLD is unavailable, the corresponding link shall not be used for any frame exchange by any of its BSS members affiliated with the AP. An AP MLD may announce the unavailability of an AP ahead of time by including the “AP unavailability parameters” in the multi-link elements transmitted by all its affiliated APs. The AP MLD may notify the unavailability ahead of time such that all STAs affiliated with the AP to be unavailable have an opportunity to decode a beacon frame containing such an indication. After a first AP becomes unavailable, the other APs of the same AP MLD my transmit the “AP unavailability parameters” in the link info field of the multi-link element transmitted by them (as shown in FIG. 5), with the AP unavailability count set to 0 and the AP unavailability duration indicating the remaining estimated time of the unavailability. An AP that is unavailable that was announced with the ‘AP unavailability duration’ subfield of the ‘AP unavailability Parameters’ field set to 65535, may be enabled by the AP MLD on or before the expiry of the time indicated in the Link Disablement Duration field. After the end of an AP unavailability, which can be inferred from the expiry of the indicated time in the AP unavailability duration, or from an increment to the BSS check beacon field, any member of the BSS that is affiliated with the AP MLD can initiate transmissions on the link with the AP of the MLD. In one embodiment, after the AP resumes operation on a link after the end of a link unavailability, it may interpret all the associated STAs to be in the doze state.

In one embodiment, only one AP of an AP MLD may become unavailable at one time, i.e., the unavailable times are non-overlapping across the different APs of an AP MLD. In this case, the STAs which are associated with the AP MLD on only the link to become unavailable may be disassociated by either the AP or the STAs, or the AP may use a base-station transition management procedure for such STAs before the start of the unavailability period. In another embodiment, more than one AP of an AP MLD can become unavailable simultaneously. In this case, all STAs which are associated with the AP MLD on only the links which are scheduled to become unavailable may be disassociated by either the AP or the STA, or the AP may use a base-station transition management procedure for such STAs before the start of the unavailability. In yet another embodiment, an AP of an AP MLD may not be scheduled to become unavailable if there are some associated STAs that are only associated with the AP MLD via this AP (excluding APs of AP MLD that are already currently unavailable).

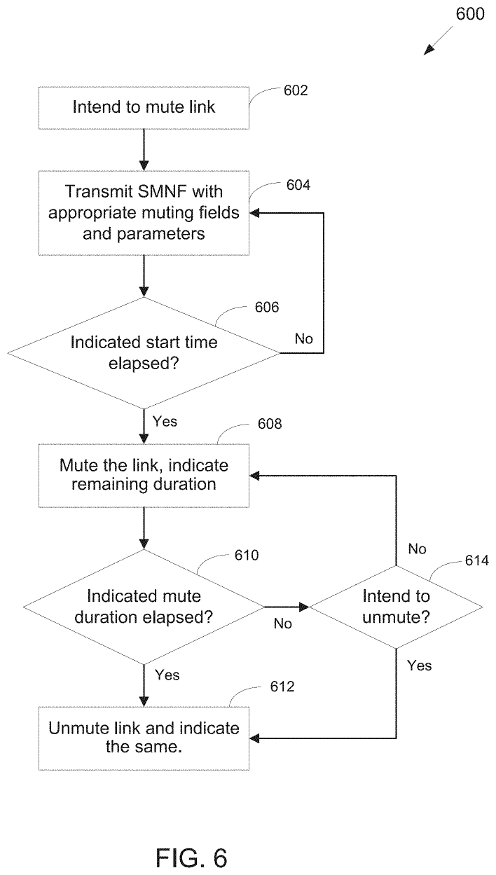

FIG. 6 illustrates an example of a flow diagram depicting the SMNF transmission and operation for an AP MLD 600 according to embodiments of the present disclosure. The embodiment of the flow diagram depicting the SMNF transmission and operation for an AP MLD 600 illustrated in FIG. 6 is for illustration only. FIG. 6 does not limit the scope of this disclosure to any particular implementation of the flow diagram depicting the SMNF transmission and operation for an AP MLD 600.

As illustrated in FIG. 6, at step 602, the AP MLD is configured to indicate an intent to mute a link. At step 604, the SMNF is transmitted with appropriate muting fields and parameters. At step 606, a determination is made whether the indicated start time has elapsed. If the indicated start time has not elapsed, then the flow reverts to step 604. If the indicated start time has elapsed, then at step 608, the link is muted and the remaining duration of unavailability is indicated. At step 610, a determination is made whether the indicated mute duration or remaining duration of unavailability has elapsed. If the indicated mute duration has elapsed, then at step 612, the link is unmuted or enabled and an indication of such is provided. If the indicated mute duration has not elapsed, then at step 614, a determination is made whether there is an intent to unmute. If there is an intent to unmute, then the link is unmuted and an indication of such is provided at step 612. If there is not an intent to unmute, then the flow reverts back to step 608.

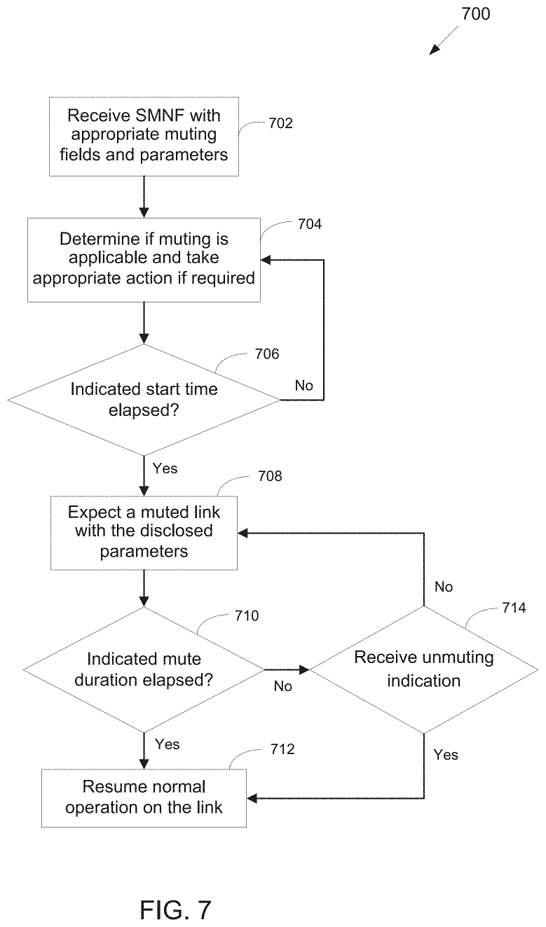

FIG. 7 illustrates an example of a flow diagram depicting the SMNF transmission and operation for a non-AP MLD 700 according to embodiments of the present disclosure. The embodiment of the flow diagram depicting the SMNF transmission and operation for a non-AP MLD 700 illustrated in FIG. 7 is for illustration only. FIG. 7 does not limit the scope of this disclosure to any particular implementation of the flow diagram depicting the SMNF transmission and operation for a non-AP MLD 700.

As illustrated in FIG. 7, at step 702, the SMNF is received with appropriate muting fields and parameters. At step 704, a determination is made whether muting is applicable and appropriate action is taken if needed. At step 706, a determination is made whether the indicated start time has elapsed. If the indicated start time has not elapsed, then the flow reverts to step 704. If the indicated start time has elapsed, then at step 708, a muted link with the disclosed parameters is expected. At step 710, a determination is made whether the indicated mute duration has elapsed. If the indicated mute duration has elapsed, then at step 712, normal operation is resumed on the link. If the indicated mute duration has not elapsed, then at step 714, a determination is made whether an unmuting indication has been received. If an unmuting indication has been received, then normal operation is resumed on the link at step 712. If an unmuting indication has not been received, then the flow reverts back to step 708.

In another embodiment, a new information element can be added to the element list which enhances the existing Quiet Element. Such an element can be included in any broadcast management frame like in beacon frames. It can also be transmitted in individually addressed frames like probe response or association response frames. An example element ID for the new element is illustrated in Table 11. In addition to the existing elements that are used in the quiet element, a new field of priority can be provided to help the DA determine if it has to comply with the quieting request. An example embodiment format of the new Prioritized Quiet Element is defined in Table 12. The quiet count is a measure of the number of TBTT to the start of the muting duration. The quiet offset may convey the number of time units (TUs) between the start of the muting and the preceding beacon transmit time. The priority field values can be similar to the ones in Table 5.

TABLE 11
Embodiment ID fields

| | | Element | | |
|---|---|---|---|---|
| Element | Element ID | ID extension | Extensible | Fragmentable |
| Prioritized Quiet | 47 | N/A | No | No |

TABLE 12
Embodiment of Service Muting Notification Frame format

| Element | | Quiet | Quiet | Quiet | Quiet | |
|---|---|---|---|---|---|---|
| ID | Length | Count | Period | Duration | Offset | Priority |
| 1 octet | 1 octet | 1 octet | 1 octet | 2 octet | 2 octet | 1 octet |

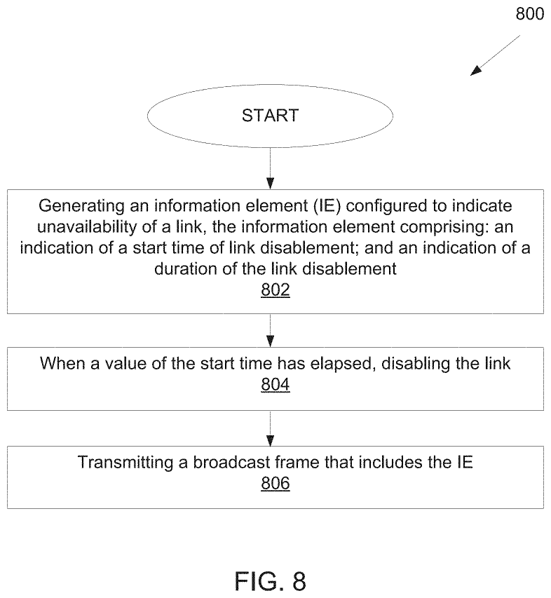

FIG. 8 illustrates a flow chart of a method 800 of wireless communication performed by an AP MLD, as may be performed by an AP such as AP 101, according to embodiments of the present disclosure. The embodiment of the method 800 illustrated in FIG. 8 is for illustration only. FIG. 8 does not limit the scope of this disclosure to any particular implementation.

As illustrated in FIG. 8, the method 800 begins at step 802. In step 802, the AP MLD (e.g., 101-103 as illustrated in FIG. 1) generates an information element (IE) configured to indicate unavailability of a link, the IE included in a broadcast frame, the IE comprising an indication of a duration of link disablement.

In step 804, when a value of the indicated link duration has elapsed, the AP MLD enables the link.

In step 806, the AP MLD transmits the broadcast frame that included the IE.

In one embodiment, the AP MLD transmits the broadcast frame that includes the IE indicating a remaining duration of the link disablement.

In one embodiment, the AP MLD transmits the broadcast frame that includes the IE indicating a reduced duration of the link disablement.

In one embodiment, the IE further comprises an indication of links to which all or a subset of affected traffic identifiers (TIDs) are re-mapped, and the AP MLD re-maps TIDs corresponding to the indicated links.

In one embodiment, the IE further comprises an indication that the link disablement is for both an uplink and a downlink, and the AP MLD disables the link based on the link disablement indication.

In one embodiment, the IE further comprises an indication of one or more link identifiers (IDs) to be disabled, and the AP MLD disables one or more links corresponding to the indicated one or more link IDs.

In one embodiment, the IE further comprises an indication of traffic identifiers (TIDs) associated with a destination address (DA) to be disabled, and the AP MLD disables traffic corresponding to the indicated TIDs.

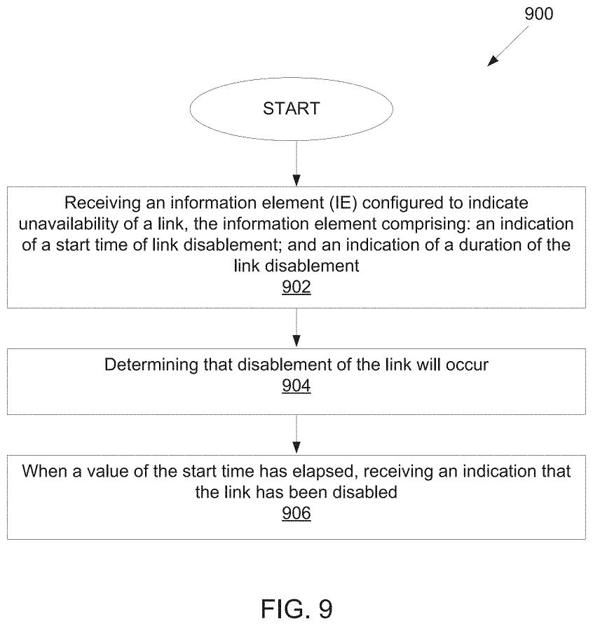

FIG. 9 illustrates a flow chart of a method 900 of wireless communication performed by a non-AP MLD, as may be performed by a non-AP MLD such as STA 111, according to embodiments of the present disclosure. The embodiment of the method 900 illustrated in FIG. 9 is for illustration only. FIG. 9 does not limit the scope of this disclosure to any particular implementation.

As illustrated in FIG. 9, the method 900 begins at step 902. In step 902, the non-AP MLD (e.g., 111-114 as illustrated in FIG. 1) receives an information element (IE) configured to indicate unavailability of a link, the IE included in a broadcast frame, the IE comprising an indication of a duration of the link disablement.

In step 904, the non-AP MLD determines that disablement of the link will occur.

In step 906, when a value of the indicated duration of the link disablement has elapsed, the transceiver is configured to receive an indication that the link has been enabled.

In one embodiment, the non-AP MLD receives the broadcast frame that includes the IE indicating a remaining duration of the link disablement.

In one embodiment, the non-AP MLD receives the broadcast frame that includes the IE indicating a reduced duration of the link disablement.

In one embodiment, the non-AP MLD receives the broadcast frame that includes the IE indicating links to which all or a subset of affected traffic identifiers (TIDs) are re-mapped, and receives an indication that TIDs corresponding to the indicated links have been re-mapped.

In one embodiment, the non-AP MLD receives the broadcast frame that includes the IE indicating that the link disablement is for both an uplink and a downlink, and receives an indication that the link has been disabled based on the link disablement indication.

In one embodiment, the non-AP MLD receives the broadcast frame that includes the IE indicating one or more link identifiers (IDs) to be disabled, and receives an indication that one or more links corresponding to the indicated one or more link IDs have been disabled.

In one embodiment, the non-AP MLD receives the broadcast frame that includes the IE indicating traffic identifiers (TIDs) associated with a destination address (DA) to be disabled, and receives an indication that traffic corresponding to the indicated TIDs has been disabled.

The above flowcharts illustrate example methods that can be implemented in accordance with the principles of the present disclosure and various changes could be made to the methods illustrated in the flowchart. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. An access point (AP) multi-link device (MLD) comprising:
a transceiver; and
a processor coupled to the transceiver, the processor configured to cause:
determining to temporarily disable a link,
based on the determination to temporarily disable the link, generating an information element comprising a duration field indicating a duration for which the link is disabled, and
transmitting a management frame including the information element.

2. The AP MLD of claim 1, wherein the processor is further configured to cause:
when the duration elapses, providing an indication that the link is enabled.

3. The AP MLD of claim 1, wherein reception of frames over the link is prohibited while the link is disabled.

4. The AP MLD of claim 1, wherein the information element further comprises a start time field indicating a start time when the link becomes disabled, and the duration field indicates a duration for which the link is disabled after the start time is reached.

5. The AP MLD of claim 4, wherein the processor is further configured to cause:
disabling the link when the start time elapses.

6. The AP MLD of claim 1, wherein the duration field indicates a remaining duration for which the link is disabled.

7. The AP MLD of claim 1, wherein the information element further comprises an indication of the link to be temporarily disabled.

8. The AP MLD of claim 1, wherein the information element further comprises traffic identifier (TID)-to-Link mapping information.

9. The AP MLD of claim 1, wherein the information element further comprises an indication of whether temporarily disabling the link is for an uplink, a downlink or both.

10. The AP MLD of claim 1, wherein the management frame is a beacon frame or a probe response frame.

11. A non-access point (AP) multi-link device (MLD) comprising:
a transceiver; and
a processor coupled to the transceiver, the processor configured to cause:
receiving a management frame including an information element, the information element comprising a duration field indicating a duration for which a link is disabled, and
temporarily disabling the link during the duration.

12. The non-AP MLD of claim 11, wherein the processor is further configured to cause:
when the duration elapses, receiving an indication that the link is enabled, and
enabling the link based on the reception of the indication that the link is enabled.

13. The non-AP MLD of claim 11, wherein transmission of frames over the link is prohibited while the link is disabled.

14. The non-AP MLD of claim 11, wherein the information element further comprises a start time field indicating a start time when the link becomes disabled, and the duration field indicates a duration for which the link is disabled after the start time is reached.

15. The non-AP MLD of claim 14, wherein the processor is further configured to cause:
disabling the link when the start time elapses.

16. The non-AP MLD of claim 11, wherein the duration field indicates a remaining duration for which the link is disabled.

17. The non-AP MLD of claim 11, wherein the information element further comprises an indication of the link to be temporarily disabled.

18. The non-AP MLD of claim 11, wherein the information element further comprises traffic identifier (TID)-to-Link mapping information.

19. A method of wireless communication performed by a non-access point (AP) multi-link device (MLD), the method comprising:
receiving a management frame including an information element, the information element comprising a duration field indicating a duration for which a link is disabled; and
temporarily disabling the link during the duration.

20. The method of claim 19, further comprising:
when the duration elapses, receiving an indication that the link is enabled; and
enabling the link based on the reception of the indication that the link is enabled.
